(19) United States
(12) Patent Application Publication
(10) Pub. No.: US 2024/0112569 A1
(43) Pub. Date: Apr. 4, 2024

(54) VEHICULAR SENSING SYSTEM AND CONTROL SYSTEM UTILIZING SHORT RANGE COMMUNICATION WITH TRANSMITTERS AT THE ROAD OR TRAFFIC SIGNS

(71) Applicant: Magna Electronics Inc., Auburn Hills, MI (US)

(72) Inventor: Nagender Reddy Kasarla, New Hudson, MI (US)

(21) Appl. No.: 18/474,581

(22) Filed: Sep. 26, 2023

Related U.S. Application Data
(60) Provisional application No. 63/377,634, filed on Sep. 29, 2022.

(51) Int. Cl. G08G 1/01; G06V 20/56; G06V 20/58; H04W 4/44

(52) U.S. Cl. CPC G08G 1/0116; G06V 20/582; G06V 20/588; H04W 4/44

(57) ABSTRACT

A vehicular driving assistance system includes a data processor configured to process sensor data captured by a sensor disposed at a vehicle. As the vehicle travels along a road, the vehicular driving assistance system receives signals from a plurality of communication devices disposed at respective geographic locations along the road and associated with respective road elements of the road. The vehicular driving assistance system, responsive to receiving respective signals from the plurality of communication devices, determines road information based on at least one selected from the group consisting of (i) the respective geographic locations of the respective communication devices and (ii) the respective road elements associated with the respective communication devices. The vehicular driving assistance system is configured to at least partially control operation of the vehicle based in part on the determined road information.

### CROSS REFERENCE TO RELATED APPLICATION

The present application claims the filing benefits of U.S. provisional application Ser. No. 63/377,634, filed Sep. 29, 2022, which is hereby incorporated herein by reference in its entirety.

### FIELD OF THE INVENTION

The present invention relates generally to a vehicle sensing system for a vehicle and, more particularly, to a vehicle sensing system that determines lane markers along a road being traveled by the vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular sensing system includes an electronic control unit (ECU) that includes electronic circuitry and associated software. The electronic circuitry includes a wireless communication module. The electronic circuitry of the ECU comprises a data processor configured to process sensor data captured by a sensor disposed at a vehicle equipped with the vehicular sensing system. The data processor processes captured sensor data for an advanced driving assistance system (ADAS) of the vehicle. The ADAS is operable to at least partially control operation of the vehicle as the vehicle travels along a road. As the vehicle travels along the road, the wireless communication module is configured to receive signals from a plurality of communication devices. Each communication device of the plurality of communication devices is disposed at a respective geographic location along the road, and associated with a respective road element of the road. Each communication device of the plurality of communication devices includes a short range wireless transmitter that is operable to wirelessly transmit the signal to the wireless communication module when the vehicle is within a threshold range of the short range wireless transmitter. The vehicular sensing system, responsive to receiving signals from the plurality of communication devices, determines road information based on at least one of the respective geographic locations of the plurality of communication devices, and the respective road elements associated with the plurality of communication devices. As the vehicle travels along the road, the wireless communication module receives a first signal from a first communication device of the plurality of communication devices. The first communication device is associated with a first road element including a lane boundary of a traffic lane of the road. The vehicular sensing system, responsive to receiving the first signal from the first communication device, determines first road information including a position of the vehicle relative to the lane boundary. As the vehicle travels along the road, the wireless communication device receives a second signal from a second communication device of the plurality of communication devices. The second communication device is associated with a second road element of the road. The vehicular sensing system, responsive to receiving the second signal from the second communication device, determines second road information different from the first road information. The ADAS is configured to at least partially control operation of the vehicle based in part on the determined first road information and the determined second road information.

Optionally, the ADAS or driving assistance system of the vehicle receives the signals from the communication devices and, responsive to receiving the signals, determines road information based on the geographic locations of the communication devices and road elements associated with the communication devices. Thus, the driving assistance system receives the communications, determines the road information, and is configured to at least partially control operation of the vehicle based in part on the determined road information.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a camera that views through a windshield of the vehicle;

FIGS. 2 and 3 are schematic views of the vehicle of FIG. 1 receiving signals at an antenna of the sensing system from short range wireless transmitters disposed at and along a road that the vehicle is travelling along and at objects and points of interest at or near or along the road; and

FIG. 4 is an environmental view of the transmitters disposed along the road and at objects and points of interest at or near or along the road.

### DESCRIPTION OF THE PREFERRED EMBODIMENTS

A vehicle sensing system or vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

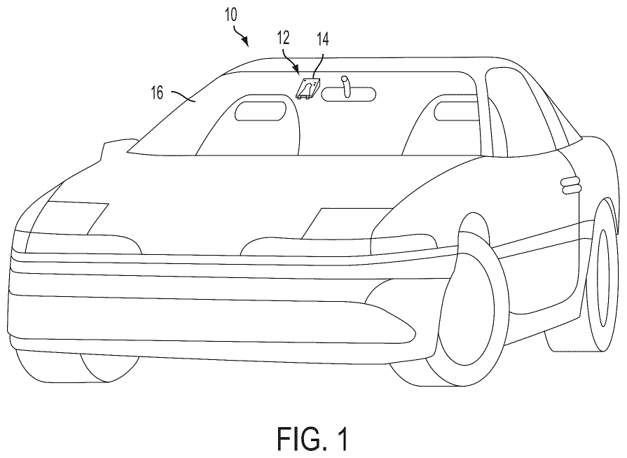

Referring now to the drawings and the illustrative embodiments depicted therein, a vision or sensing system 12 for a vehicle 10 includes at least one exterior viewing imaging sensor or camera, such as a forward viewing imaging sensor or camera of a camera module 14, which may be disposed at and behind the windshield 16 of the vehicle and viewing forward through the windshield 16 so as to capture image data representative of the scene occurring forward of the vehicle (FIG. 1). Optionally, the system may include multiple exterior viewing imaging sensors or cameras, such as a forward viewing camera at the front of the vehicle, and a sideward/rearward viewing camera at respective sides of the vehicle, and a rearward viewing camera at the rear of the vehicle, which capture images exterior of the vehicle. The camera or cameras each include a lens for focusing images at or onto an imaging array or imaging plane or imager of the camera. The forward viewing camera 14 disposed at the windshield 16 of the vehicle views through the windshield 16 and forward of the vehicle, such as for a machine vision system (such as for traffic sign recognition, headlamp control, pedestrian detection, collision avoidance, lane marker detection and/or the like). The vision system 12 includes a control or electronic control unit (ECU) having electronic circuitry and associated software, with the electronic circuitry including a data processor or image processor that is operable to process image data captured by the camera or cameras, whereby the ECU may detect or determine presence of objects or the like and/or the system provide displayed images at a display device for viewing by the driver of the vehicle. The data transfer or signal communication from the camera to the ECU may comprise any suitable data or communication link, such as a vehicle network bus or the like of the equipped vehicle.

Image data and sensor data captured by the sensing system 12 is processed by the ECU to provide an advanced driving assistance system (ADAS) of the vehicle. For example, the ADAS may at least partially control operation of the vehicle (e.g., acceleration, steering, braking, and the like) as the vehicle travels along a road. The ADAS may rely on the processed image data, other sensor data captured by sensors at the vehicle (e.g., radar, lidar, and the like), and signals received from other systems in communication with the ADAS (e.g., GPS data received from a navigation system of the vehicle). The ADAS may perform one or more control functions when an autonomous or semi-autonomous control mode is activated, such as a lane change or lane keep function, automatic braking, maneuvering in and out of parking spots, maintaining a following distance to a lead vehicle, and the like. For example, the vision system and ADAS may utilize characteristics of the systems described in U.S. Publication Nos. US-2019-0073541 and/or US-2019-0250269, which are hereby incorporated herein by reference in their entireties.

Sometimes, when travelling along the road, image data, sensor data, GPS data, and/or other information relied upon by the ADAS may become unreliable. For example, the ADAS may process image data to determine lane markings of a road lane that the vehicle is travelling in, and environmental conditions (e.g., precipitation, fog, low light conditions, and the like) or road conditions (e.g., snow or ice covering the road, or dirt roads) or other conditions (e.g., dirt or bugs or other debris at the camera lens) may cause the ADAS to be unable to determine lane markings based on the processed image data. Furthermore, the ADAS may determine position of the vehicle based on GPS or navigation data and the GPS data may be outdated or inaccurate to current road conditions, such as when the road is under construction.

In other words, the ADAS uses image data captured by the front camera module and/or high precision GPS/navigation data to perform functions, such as to change lanes, when operating in an autonomous or semi-autonomous control mode. However, this has some draw backs in some circumstances, such as snowy or foggy weather or dirt road conditions. These conditions make it difficult for the front camera module to consistently provide good and accurate perception data for ADAS functions like lane change and lane keep scenarios. Furthermore, locations where the lane markings are changed or moved, and may or may not be updated in the GPS/navigation system, such as construction zones, limit the capabilities of the ADAS system.

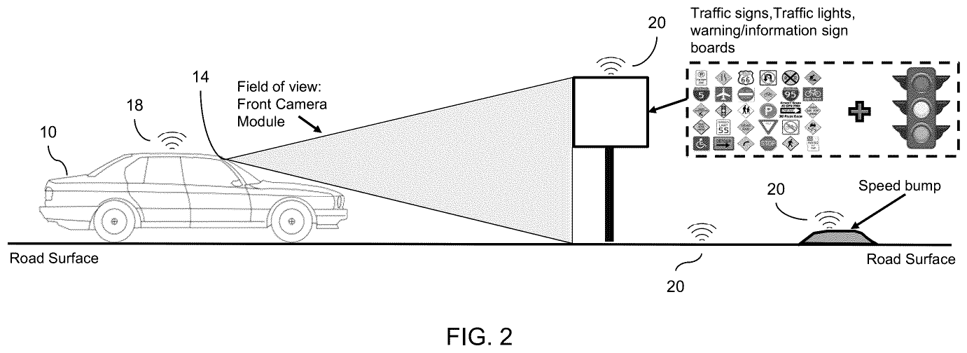

Thus, as shown in FIG. 2, the sensing system 12 includes a wireless communications module 18, such as a transmitting and/or receiving antenna, configured to receive short range communications from transmitters or signal emitters or communication devices 20 disposed along the road. The wireless communications module 18 may be disposed at any suitable position on the vehicle and in communication with the ECU providing the ADAS. For example, the wireless communications module 18 may comprise an antenna disposed at the electronic circuitry of the ECU. The short range communication signal transmitters 20 may emit BLUETOOTH® or radio frequency (RF) or any suitable short range signal. That is, the communication device 20 includes a short range wireless transmitter operable to wirelessly communicate with the wireless communications module 18 of the vehicle when the vehicle is within a threshold range of the communication device 20, such as when the vehicle is closer than 300 feet, 100 feet, 50 feet, 10 feet, 5 feet, 1 foot, or less from the communication device 20. The transmitters 20 may be electrically powered in any suitable way, such as directly electrically powered (i.e., electrically connected to a power grid), powered via a rechargeable battery, or solar powered. For example, the transmitters may utilize characteristics of the road-based transmitters described in U.S. Pat. No. 9,729,636, which is hereby incorporated herein by reference in its entirety.

As the vehicle travels along the road, the sensing system 12 receives signals from the transmitters 20 and determines position of the transmitters 20 relative to the vehicle 10 (or a position of the vehicle relative to the transmitters) based on the signals. For example, the system 12 may determine position of the transmitters 20 based on a relative signal strength of the signal from the transmitter 20 and/or an identification tag or message included in the signal. The signal from the transmitter 20 may include a known geographic location of the transmitter so that the system 12 may determine a geographic location of the vehicle based on the relative positioning of the vehicle and transmitters. For example, the signal may identify GPS coordinates of the transmitter 20 or a position of the transmitter 20 relative to the road (e.g., a distance from an edge of the road at a known mile marker along the road).

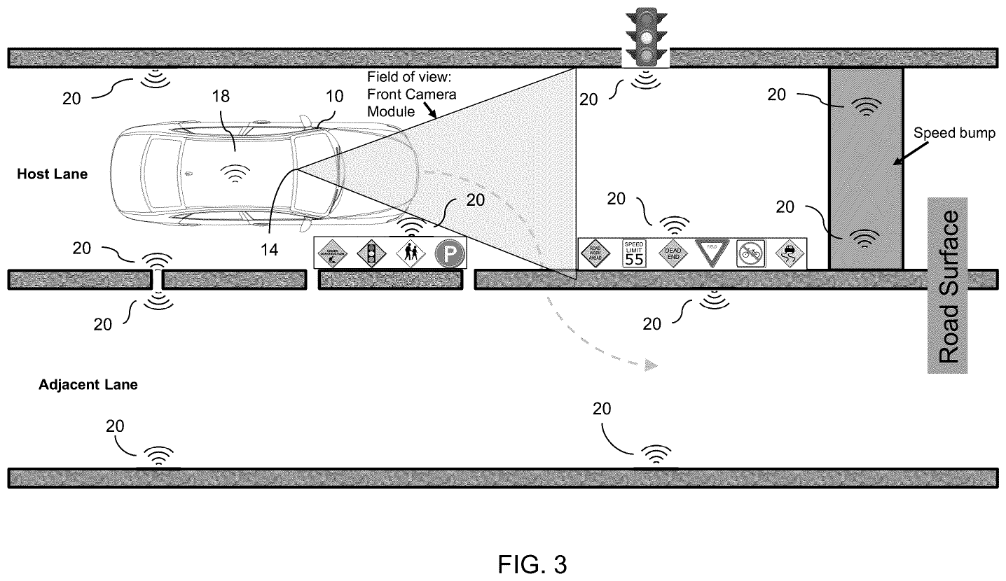

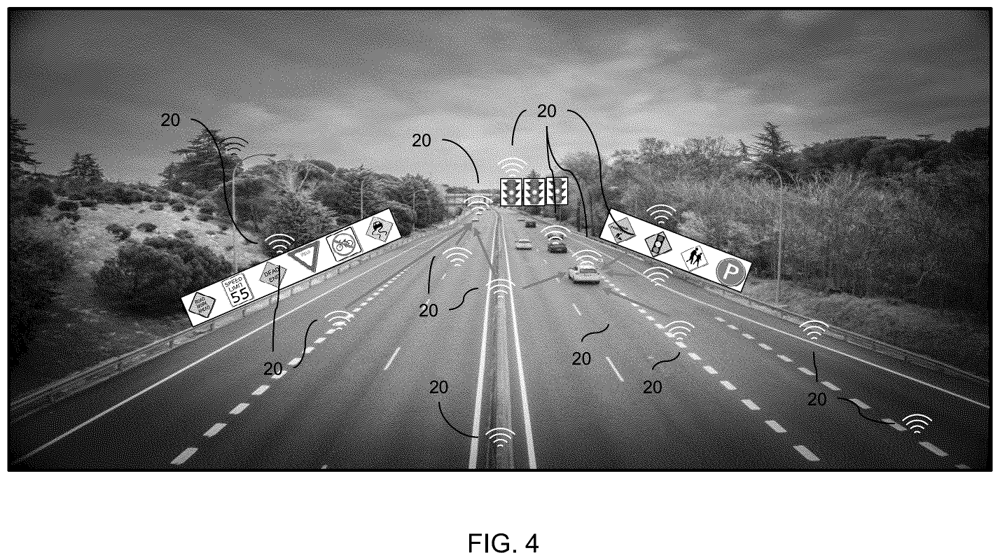

As shown in FIGS. 3 and 4, the transmitters 20 may be positioned at regular intervals and at known positions along the road surface, such as identifying edges of the road, lane markers identifying lanes of travel along the road, medians or barriers between opposite directions of travel, curves along the road, and the like. The signal from the transmitter 20 may identify the position of the transmitter along the road. For example, the transmitters 20 may transmit lane boundary information to the vision system 12 so that the ADAS may determine a position of the vehicle relative to a lane boundary. Thus, the system 12 may be configured to receive the signals from multiple transmitters 20 and recognize a pattern or orientation of the position of transmitters relative to one another to determine the shape of the road and position of the vehicle along the road. In other words, the system 12 may effectively map the road and environment surrounding the vehicle as it travels along the road in real time based on the received signals from the transmitters 20, and thus the ADAS may accurately and reliably maneuver the vehicle along the road.

Furthermore, the transmitters 20 may be positioned at and identify objects or points of interest along the road, such as a speed bump (e.g., to alert the vehicle that the speed bump is ahead) or highway exit or entrance ramp. Thus, the ADAS may react appropriately to the point of interest, such as to slow down in preparation for the vehicle passing over the speed bump, or to anticipate a potential other vehicle merging from the nearby entrance ramp.

Moreover, the transmitters 20 may be positioned at and identify road signs or other road information that may affect how the ADAS controls operation of the vehicle along the road. In other words, the transmitters 20 may provide information to the vehicle that may or may not be dependent upon the location of the transmitter relative to the vehicle. For example, the transmitter 20 may be disposed at a speed limit sign where the signal from the transmitter identifies the speed limit identified by the sign and the position of the transmitter may be used by the ADAS to determine the geographic location where the speed limit goes into effect.

Furthermore, the transmitter 20 may be associated with a road condition that is not dependent on the position of the vehicle relative to the transmitter, such as a transmitter 20 identifying a one way only sign, where the signal from the transmitter includes the road condition. The transmitter 20 may be disposed at and identify information related to any suitable road condition or road sign, such as traffic signs, traffic lights, warning information signs, or road identification signs. For example, the transmitter 20 may be associated with road signs identifying lane merging zones, interstate or freeway or road markers, railroad crossings, construction zones, tow away zones, bike lanes or bike routes, traffic lights, crosswalks, parking areas, one way only roads, school zones, bus stops, speed limits, dead ends, yield signs, curves in the road, handicap access zones or parking spots, detours, stop signs, no parking zones, and the like. Signal from a transmitter 20 at a traffic light may identify the current signal shown by the traffic light (e.g., red, yellow, or green light).

As shown in FIG. 4, the wireless communications module 18 at the vehicle 10 may also receive short range communications from transmitters 20 disposed at other vehicles. Thus, the vision system 12 may receive signals from transmitters 20 disposed along the road surface, at points of interest along the road, associated with road signs or road conditions, and/or disposed at other vehicles to determine a position of the vehicle relative to the road (e.g., lane markers, curves in the road, and road edges), road conditions (e.g., speed limits, construction zones, and direction of travel), and positions of points of interest (e.g., speed bumps, entrance and exit ramps, intersections, and crosswalks) along the road so that the ADAS may react and control operation of the vehicle according to the information from the vision system.

The vision system may receive the signals from the transmitters 20 as the vehicle travels along the road, process the signals (e.g., determine relative signal strength and any associated identification from the transmitter), and communicate road information based on the processed signals to the ADAS. The ADAS may receive the road information from the vision system and utilize the road information regardless of the reliability of image data or other sensor data used by the ADAS to control operation of the vehicle. That is, the vision system may continuously determine and provide the road information when signals from the transmitters are available (i.e., the transmitters are within communicable range of the vehicle).

Optionally, the ADAS may use the road information based on transmitter signals to confirm or reject similar information determined based on image or sensor data. For example, the image data may be unreliable (e.g., occluded or poorly lighted) and the road information from the vision system may confirm or reject determinations made using the image data (such as traffic sign recognition or determination of presence of other vehicles near the equipped vehicle). Optionally, the ADAS may only use the road information based on transmitter signals when the other, primary sensor data is compromised. For example, the ADAS may communicate a signal to the vision system or wireless communications module 18 to begin receiving signals from transmitters 20 when primary sensor data quality is low.

Optionally, the wireless communications module 18 may enable the vision system 12 and the ADAS to determine the position of objects and features of the road (e.g., lane markers) that are outside the range of vision or sensing of other sensors at the vehicle, such as the forward viewing camera module 14. For example, the wireless communication module 18 may receive communications from lane boundary transmitters 20 positioned behind the vehicle and/or in lanes adjacent to the one in which the vehicle is travelling, while the forward viewing camera module 14 may only be able to capture image data representative of lane markers forward of the vehicle and in the same lane of travel of the vehicle.

That is, in addition to processing sensor data captured by cameras and sensors at the vehicle, the ADAS of the vehicle will receive and utilize BLUETOOTH® emitter device data and RF device data, which are strategically placed on the roads to provide data regarding lane markings to, for example, enable the lane keep and lane change functions of the ADAS. Additionally, the emitter devices may be extended to other scenarios, such as speed bumps, traffic sign data, other road safety information, and/or other vehicles.

By way of example, transmitters 20 may be disposed at positions and features within the environment where it is especially critical for the vision system 12 to determine the position of the equipped vehicle relative to the transmitter 20. For example, the vision system 12 may be equipped by a bus or shuttle or taxi and the transmitter 20 may be disposed at a pickup location so that the autonomous control system may more accurately maneuver the vehicle to the pickup location. Further, transmitters 20 may be disposed at stop signs, pedestrian crosswalks, school zones, and the like so that the autonomous control system may become aware of its presence at or near the transmitter 20 and its corresponding geographic or road feature.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controls at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assistance system, the vehicular driving assistance system comprising:
an electronic control unit (ECU) disposed at a vehicle equipped with the vehicular driving assistance system, wherein the ECU comprises electronic circuitry and associated software;
wherein the electronic circuitry of the ECU comprises a data processor configured to process sensor data captured by a sensor disposed at the vehicle;
wherein the vehicular driving assistance system is operable to at least partially control operation of the vehicle as the vehicle travels along a road;
wherein, as the vehicle travels along the road, the vehicular driving assistance system wirelessly receives signals from a plurality of communication devices, and wherein each communication device of the plurality of communication devices is (i) disposed at a respective geographic location along the road and (ii) associated with a respective road element of the road;
wherein each communication device of the plurality of communication devices comprises a wireless transmitter that is operable to wirelessly transmit a respective signal to the vehicle when the vehicle is within a threshold range of the wireless transmitter;
wherein the vehicular driving assistance system, responsive to receiving respective signals transmitted from the plurality of communication devices, determines road information based on at least one selected from the group consisting of (i) the respective geographic locations of respective communication devices and (ii) the respective road elements associated with respective communication devices;
wherein, as the vehicle travels along the road, the vehicular driving assistance system receives a first signal transmitted from a first communication device of the plurality of communication devices, and wherein the first communication device is associated with a first road element comprising a lane boundary of a traffic lane of the road;
wherein the vehicular driving assistance system, responsive to receiving the first signal transmitted from the first communication device, determines first road information comprising a position of the vehicle relative to the lane boundary;
wherein, as the vehicle travels along the road, the vehicular driving assistance system receives a second signal transmitted from a second communication device of the plurality of communication devices, and wherein the second communication device is associated with a second road element of the road;
wherein the vehicular driving assistance system, responsive to receiving the second signal transmitted from the second communication device, determines second road information different from the first road information; and
wherein the vehicular driving assistance system is configured to at least partially control operation of the vehicle based in part on the determined first road information and the determined second road information.

2. The vehicular driving assistance system of claim 1, wherein the second road information comprises a position of the vehicle relative to the geographic location of the second communication device different from the geographic location of the first communication device.

3. The vehicular driving assistance system of claim 1, wherein the second road element comprises a speed bump disposed along the road, and wherein the second road information comprises a position of the vehicle relative to the speed bump.

4. The vehicular driving assistance system of claim 1, wherein the second road element comprises a road sign disposed along the road, and wherein the second road information comprises traffic instructions based on the road sign.

5. The vehicular driving assistance system of claim 4, wherein the road sign comprises one selected from the group consisting of (i) a stop sign, (ii) a speed limit sign, (iii) a merging lanes sign, (iv) a pedestrian crossing sign and (v) a construction zone sign.

6. The vehicular driving assistance system of claim 1, wherein the second road element comprises a traffic light disposed along the road, and wherein the second road information comprises a current traffic signal of the traffic light.

7. The vehicular driving assistance system of claim 1, wherein the vehicular driving assistance system, based on the respective signals received from the plurality of communication devices, determines the respective geographic locations of the respective communication devices.

8. The vehicular driving assistance system of claim 7, wherein the vehicular driving assistance system determines the respective geographic locations of the respective communication devices based on relative signal strengths of the signals received from the respective communication devices.

9. The vehicular driving assistance system of claim 1, wherein the respective signals from the plurality of communication devices identify the respective geographic locations of the respective communication devices.

10. The vehicular driving assistance system of claim 1, wherein the respective signals from the plurality of communication devices identify the respective road elements associated with the respective communication devices.

11. The vehicular driving assistance system of claim 1, wherein the vehicular driving assistance system at least partially controls operation of the vehicle based in part on the determined first road information and the determined second road information only when processing of the captured sensor data is compromised.

12. A vehicular driving assistance system, the vehicular driving assistance system comprising:
an electronic control unit (ECU) disposed at a vehicle equipped with the vehicular driving assistance system, wherein the ECU comprises electronic circuitry and associated software;
wherein the electronic circuitry of the ECU comprises a data processor configured to process sensor data captured by a sensor disposed at the vehicle;
wherein the vehicular driving assistance system is operable to at least partially control operation of the vehicle as the vehicle travels along a road;
wherein, as the vehicle travels along the road, the vehicular driving assistance system wirelessly receives signals from a plurality of communication devices, and wherein each communication device of the plurality of communication devices is (i) disposed at a respective geographic location along the road and (ii) associated with a respective road element of the road;
wherein each communication device of the plurality of communication devices comprises a wireless transmitter that is operable to wirelessly transmit a respective signal to the vehicle when the vehicle is within a threshold range of the wireless transmitter;
wherein the vehicular driving assistance system, responsive to receiving respective signals transmitted from the plurality of communication devices, determines road information based on at least (i) the respective geographic locations of respective communication devices and (ii) the respective road elements associated with respective communication devices;
wherein the vehicular driving assistance system determines the respective geographic locations of the respective communication devices based on relative signal strengths of the signals received from the respective communication devices;
wherein, as the vehicle travels along the road, the vehicular driving assistance system receives a first signal transmitted from a first communication device of the plurality of communication devices, and wherein the first communication device is associated with a first road element comprising a lane boundary of a traffic lane of the road;
wherein the vehicular driving assistance system, responsive to receiving the first signal transmitted from the first communication device, determines first road information comprising a position of the vehicle relative to the lane boundary;
wherein, as the vehicle travels along the road, the vehicular driving assistance system receives a second signal transmitted from a second communication device of the plurality of communication devices, and wherein the second communication device is associated with a second road element of the road;
wherein the vehicular driving assistance system, responsive to receiving the second signal transmitted from the second communication device, determines second road information different from the first road information; and
wherein the vehicular driving assistance system is configured to at least partially control operation of the vehicle based in part on the determined first road information and the determined second road information.

13. The vehicular driving assistance system of claim 12, wherein the second road information comprises a position of the vehicle relative to the geographic location of the second communication device different from the geographic location of the first communication device.

14. The vehicular driving assistance system of claim 12, wherein the second road element comprises a speed bump disposed along the road, and wherein the second road information comprises a position of the vehicle relative to the speed bump.

15. The vehicular driving assistance system of claim 12, wherein the second road element comprises a road sign disposed along the road, and wherein the second road information comprises traffic instructions based on the road sign.

16. The vehicular driving assistance system of claim 12, wherein the second road element comprises a traffic light disposed along the road, and wherein the second road information comprises a current traffic signal of the traffic light.

17. The vehicular driving assistance system of claim 12, wherein the vehicular driving assistance system at least partially controls operation of the vehicle based in part on the determined first road information and the determined second road information only when processing of the captured sensor data is compromised.

18. A vehicular driving assistance system, the vehicular driving assistance system comprising:
an electronic control unit (ECU) disposed at a vehicle equipped with the vehicular driving assistance system, wherein the ECU comprises electronic circuitry and associated software;
wherein the electronic circuitry of the ECU comprises a data processor configured to process sensor data captured by a sensor disposed at the vehicle;
wherein the vehicular driving assistance system is operable to at least partially control operation of the vehicle as the vehicle travels along a road;
wherein, as the vehicle travels along the road, the vehicular driving assistance system wirelessly receives signals from a plurality of communication devices, and wherein each communication device of the plurality of communication devices is (i) disposed at a respective geographic location along the road and (ii) associated with a respective road element of the road;
wherein each communication device of the plurality of communication devices comprises a wireless transmitter that is operable to wirelessly transmit a respective signal to the vehicle when the vehicle is within a threshold range of the wireless transmitter;
wherein the vehicular driving assistance system, responsive to receiving respective signals transmitted from the plurality of communication devices, determines road information based on at least one selected from the group consisting of (i) the respective geographic locations of respective communication devices and (ii) the respective road elements associated with respective communication devices;
wherein, as the vehicle travels along the road, the vehicular driving assistance system receives a first signal transmitted from a first communication device of the plurality of communication devices, and wherein the first communication device is associated with a first road element comprising a lane boundary of a traffic lane of the road;
wherein the vehicular driving assistance system, responsive to receiving the first signal transmitted from the first communication device, determines first road information comprising a position of the vehicle relative to the lane boundary;
wherein, as the vehicle travels along the road, the vehicular driving assistance system receives a second signal transmitted from a second communication device of the plurality of communication devices, and wherein the second communication device is associated with a second road element of the road;
wherein the vehicular driving assistance system, responsive to receiving the second signal transmitted from the second communication device, determines second road information different from the first road information;
wherein the second road information comprises a position of the vehicle relative to the geographic location of the second communication device different from the geographic location of the first communication device;
wherein the vehicular driving assistance system is configured to at least partially control operation of the vehicle based in part on the determined first road information and the determined second road information; and
wherein the vehicular driving assistance system at least partially controls operation of the vehicle based in part on the determined first road information and the determined second road information only when processing of the captured sensor data is compromised.

19. The vehicular driving assistance system of claim 18, wherein the vehicular driving assistance system, based on the respective signals received from the plurality of communication devices, determines the respective geographic locations of the respective communication devices.

20. The vehicular driving assistance system of claim 18, wherein the respective signals from the plurality of communication devices identify the respective geographic locations of the respective communication devices.
